(19) United States
(12) Patent Application Publication
(10) Pub. No.: US 2015/0156615 A1
(43) Pub. Date: Jun. 4, 2015

(54) METHOD FOR UE TO REPORT ACCESSORIAL INFORMATION

(71) Applicant: POTEVIO INFORMATION TECHNOLOGY CO., LTD., Beijing (CN)

(72) Inventors: Weidong Gao, Beijing (CN); Liangang Chi, Beijing (CN); Huan Zhang, Beijing (CN); Pei Lin, Beijing (CN); Zhe Chen, Beijing (CN); Yu Pan, Beijing (CN); Xinghang Gao, Beijing (CN)

(73) Assignee: POTEVIO INFORMATION TECHNOLOGY CO., LTD., Beijing (CN)

(21) Appl. No.: 14/402,289

(22) PCT Filed: Dec. 7, 2012
(86) PCT No.: PCT/CN2012/086189

§ 371 Date: Nov. 19, 2014

(30) Foreign Application Priority Data
May 23, 2012 (CN) 201210162303.4

(51) Int. Cl. H04W 4/16; H04W 4/02; H04W 52/02; H04W 68/02

(52) U.S. Cl. CPC H04W 4/16; H04W 68/02; H04W 4/025; H04W 52/0212

(57) ABSTRACT

The present invention provides a method for a User Equipment UE to report auxiliary information, comprising the following steps: an eNodeB, eNB, transmits to the UE a request signaling for reporting auxiliary information; after receiving the request signaling, the UE reports to the eNB the auxiliary information corresponding to the request signaling for reporting auxiliary information. The present invention also provides some other methods for the UE to report auxiliary information. The scheme of the present invention ensures that the UE can report auxiliary information to the eNB instantly and exactly, in the case that no high complexity and signaling overhead of the UE is introduced.

The present application claims the priority to Chinese Patent Application No. 201210162303.4, entitled as “METHOD FOR REPORTING AUXILIARY INFORMATION BY UE”, filed on May 23, 2012 with Chinese State Intellectual Property Office, which is incorporated herein by reference in its entirety.

### FIELD

The disclosure relates to the field of mobile communication, in particular to a method for reporting auxiliary information by user equipment (UE).

### BACKGROUND

In a new generation of wireless communication network, there are increasing types of communication devices, such as smartphones, laptops and embedded modems, etc. Meanwhile, wireless applications are increasingly diversified, and concurrent running of multiple types of applications is supported in many devices. Due to the great variety of communication devices and applications, numerous service types may arise. Lots of wireless applications require seamless always-on experience, and when the connection is provided in the radio access network (RAN), a compromise among power consumption of user equipment (UE), user experience, data transmission latency, network efficiency and control signaling overhead needs to be considered.

A traditional long term evolution (LTE) access network protocol is designed based on characteristic of full buffer service, without considering affection of diversified service types. To meet requirement for low power consumption of the UE, low control signaling overhead and low data transmission latency in diversified service applications, the conventional LTE access network standard must be enhanced effectively.

A LTE/LTE-Advanced system uses discontinuous reception (DRX) technology to reduce power consumption of the UE. The DRX technology is introduced mainly for non-real-time service, since for the non-real-time service, there is always a period of time in which a mobile phone does not need to continuously monitor downlink data. In DRX technology, power consumption of the UE is reduced through the discontinuous reception. To enable a base station (eNB) to reasonably configure DRX parameters to adapt to UE services with different characteristics and different moving speeds of the UE, the UE needs to provide the network with some necessary auxiliary information, since it is easier for the UE to acquire the information as compared with the network. In addition, eNB may perform state management according to the auxiliary information reported by the UE, i.e., controlling the UE to be in a connected state or an idle state, thereby saving power consumption of the UE, reducing control signaling overhead of state transition and decreasing data transition latency. Currently, extensive research on what kind of auxiliary information is needed to be provided to the eNB from the UE is carried on in the 3rd generation partnership project (3GPP). From current research situation, possible auxiliary information includes:

(1) data/service characteristic, such as average arrival amount of packets and average arrival interval of packets, etc;

(2) movement speed/a moving state of the UE;

(3) UE preference for time latency/power consumption/DRX.

In 3GPP, after determination of the necessary information needing to be reported by the UE, a necessary management mechanism of reporting auxiliary information also needs to be defined to ensure that the UE may report necessary auxiliary information timely and accurately while avoiding unnecessary reporting from the UE and reducing signaling overhead. So far, the management mechanism of reporting auxiliary information is not researched in 3GPP.

### SUMMARY

The disclosure provides a method for reporting auxiliary information by a UE, which may ensure that the UE may report the auxiliary information to an eNB timely and accurately without introducing high UE complexity and high signaling overhead.

A method for reporting auxiliary information by a UE, provided according to an embodiment of the disclosure, includes following steps:

transmitting, by a base station, a request signaling to the UE for requesting auxiliary information report; and

reporting, by the UE, the auxiliary information corresponding to the request signaling for requesting auxiliary information report to the base station upon receiving the request signaling.

Preferably, the request signaling for requesting auxiliary information report corresponds to one item of the auxiliary information.

Preferably, the request signaling for requesting auxiliary information report carries a list including multiple items of the auxiliary information.

Another method for reporting auxiliary information by a UE is further provided according to an embodiment of the disclosure. The method includes following steps:

configuring, by a base station, a reporting period for the UE; and

reporting, by the UE, the auxiliary information to the base station at a moment satisfying the reporting period.

Preferably, the configuring, by the base station, the reporting period for the UE includes: configuring, by the base station, a periodical reporting timer, which times for a time duration, for the UE through radio resource control RRC signaling; and the reporting, by the UE, auxiliary information to the base station at the moment satisfying the reporting period includes: reporting, by the UE, the auxiliary information when the periodical reporting timer expires, and resetting, by the UE, the periodical reporting timer after the auxiliary information is reported.

Preferably, each item of the auxiliary information corresponds to a separate periodical reporting timer, and/or multiple items of auxiliary information correspond to a same periodical reporting timer.

Yet another method for reporting auxiliary information by a UE is provided according to an embodiment of the disclosure. The method includes following steps:

determining, by the UE, whether a condition for reporting the auxiliary information is satisfied, if the condition is satisfied, reporting, by the UE, the auxiliary information corresponding to the condition.

Preferably, the auxiliary information is a service characteristic, and the condition of reporting the auxiliary information is that the service characteristic changes and/or a change of the service characteristic succeeds a preset threshold, and the auxiliary information reported by the UE is the changed service characteristic.

Preferably, a first mapping table is configured for the UE in advance, the first mapping table includes at least two quantization levels, each of the quantization levels corresponds to a numerical range of a corresponding service characteristic and a quantization level index;

the condition for reporting the auxiliary information is that the quantization level corresponding to the service characteristic for the UE changes; and

the auxiliary information reported by the UE is a quantization level corresponding to the changed service characteristic or an index value corresponding to the changed service characteristic.

Preferably, the service characteristic is an average size of packets or an average arrival interval of packets.

Preferably, the condition for reporting the auxiliary information is that a moving state of the UE changes, and the reported auxiliary information is the changed moving state.

Preferably, the condition for reporting the auxiliary information is that a change in a moving speed of the UE succeeds a preset threshold, and the reported auxiliary information is a current moving speed.

Preferably, the condition for reporting the auxiliary information is that a DRX configuration of the UE changes, and the reported auxiliary information is the changed DRX configuration.

Preferably, the UE configures a reporting limit timer corresponding to the auxiliary information; and

reporting, by the UE, the auxiliary information includes: determining, by the UE, whether the reporting restricted timer corresponding to the auxiliary information to be reported expires, if the reporting restricted timer expires, reporting the auxiliary information and resetting the reporting restricted timer, and if the reporting restricted timer does not expire, abandoning the reporting of the auxiliary information.

It can be seen from above technical solutions that UE reports auxiliary information to a base station according to instructions from the base station or according to event-triggering. In addition, to avoid unnecessary information reporting, a restricted mechanism for the reporting may be considered to be introduced, in which the UE does not report a same item of the auxiliary information in a time period T since the transmission of the auxiliary information. With the solutions of the disclosure, it is ensured that the UE may report auxiliary information to the eNB timely and accurately without introducing high UE complexity and high signaling overhead.

### BRIEF DESCRIPTION OF THE DRAWINGS

Drawings are provided to facilitate further understanding of the disclosure and form a part of the specification; the drawings, together with the embodiments of the disclosure, may be used to explain the disclosure, but not to limit the disclosure. In the drawings:

FIG. 1 is a schematic diagram showing that each item of auxiliary information corresponds to a separate request signaling according to a first embodiment of the disclosure; and

FIG. 2 is a schematic diagram showing that a request signaling includes multiple items of auxiliary information according to the first embodiment of the disclosure.

### DETAILED DESCRIPTION

To describe technical principle, features and technical effects of the technical solutions in the disclosure more clearly, in the following the solutions of the disclosure are described in detail in conjunction with specific embodiments.

According to the first embodiment of the disclosure, a method is provided in which eNB controls user equipment (UE) to report auxiliary information. Initially, eNB transmits a request signaling to the UE for requesting auxiliary information report, and the UE reports corresponding auxiliary information to the eNB after receiving the request signaling.

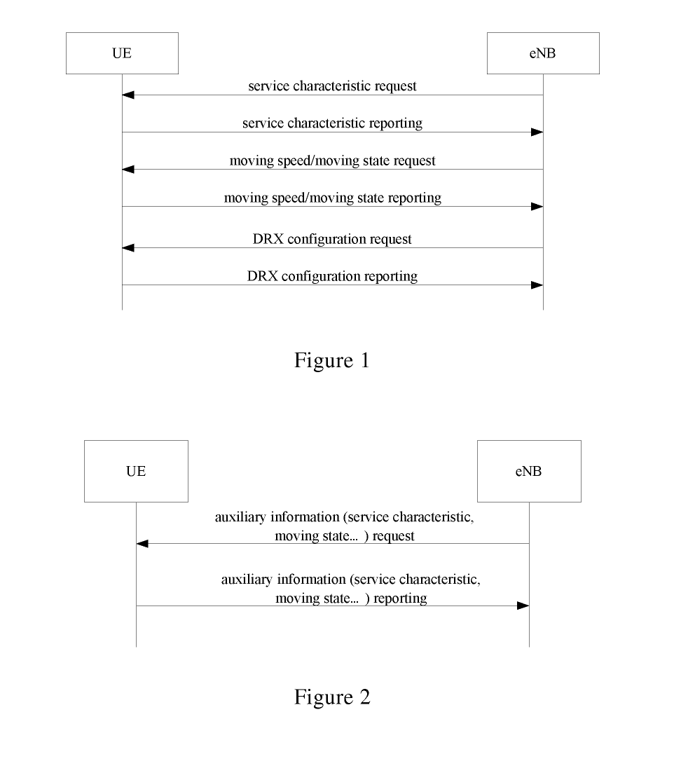

The request signaling may include only one item of the auxiliary information. As shown in FIG. 1, each item of auxiliary information corresponds to a separate request signaling. Upon receiving one request signaling, the UE reports corresponding auxiliary information to the eNB.

Alternatively, single request signaling may include multiple items of auxiliary information. As shown in FIG. 2, the request signaling carries a list including multiple items of auxiliary information, and the UE reports relevant auxiliary information to the eNB according to content of the list. The eNB reasonably requests the UE to transmit necessary auxiliary information as desired.

According to the second embodiment of the disclosure, a method is provided in which UE automatically triggers to report auxiliary information. The UE only reports auxiliary information when necessary, and there is no need for the network to transmit requesting information. Depending on different triggering events, the automatic reporting of the UE may be categorized into periodic reporting and event-triggered reporting.

A UE may periodically trigger auxiliary information report in such a way: an eNB configures a reporting period for the UE in advance, and the UE reports the auxiliary information to the eNB at the moments satisfying the reporting period.

Specifically, the eNB configures for the UE a periodical reporting timer, which times for a certain time length, through radio resource control (RRC) signaling, and the UE reports auxiliary information whenever the periodical reporting timer expires, and resets the periodical reporting timer after reporting the auxiliary information. Each item of the auxiliary information may correspond to one separate periodical reporting timer, for example, average size of packets corresponds to a timer Timer_{—}1, average arrival interval of packets corresponds to a timer Timer_{—}2, and a moving state corresponds to a timer Timer_{—}3. Alternatively, multiple items of auxiliary information may correspond to a same periodical reporting timer, for example, the average size of packets, the average arrival interval of packets and the moving state all correspond to a common timer. When the periodical time expires, the UE reports relevant auxiliary information. The two cases may occur at the same time, i.e., for some items of the auxiliary information, each item of the auxiliary information corresponds to one timer, and for some other items of auxiliary information, multiple items of the auxiliary information correspond to a common timer.

The UE may report auxiliary information in an event-triggered way. The so-called event-triggered reporting means that the UE reports auxiliary information only if a certain condition is satisfied. Taking the case that change of service characteristic triggers reporting as an example, in a case that characteristic (for example, average size of packets, average arrival interval of packets) of an ongoing service on the UE changes and/or the change exceeds a preset threshold, the UE reports information about the service characteristic to the network. The triggering threshold is configured for the UE by the network.

If the reporting is triggered by the change of the average size of packets, a threshold (such as 30 bytes) may be defined in advance. In a case that average size of packets during a certain time period succeeds the threshold, the UE triggers the reporting, content of which is the changed size of the packets. A mapping table may also be configured for the UE, each item in the table represents a certain size range of packets. A specific example is shown in Table 1 in which 4 quantization levels are defined. In a case that the quantization level corresponding to the average size of packets at the UE changes (for example, from a value in a range of 0-50 to a value in a range of 50-100), the UE reports to the eNB the quantization level or an index value corresponding to the average size of packets.

TABLE 1
Quantization Table of Size of Packets

| | Quantization | Average size of |
|---|---|---|
| Index | level | packets (Byte) |
| 00 | Very low | 0-50 |
| 01 | Low | 50-100 |
| 10 | Medium | 100-250 |
| 11 | High | greater than 250 |

If the reporting is triggered by a change of an average arrival interval of packets, a threshold (such as 5 seconds) may be defined in advance. In a case that the average arrival interval of packets succeeds the threshold, the UE triggers the reporting, content of which is the changed average arrival interval of packets. A mapping table may also be defined, and each item in the table represents a certain range for the average arrival interval of packets. A specific example is shown in Table 2 in which 4 quantization levels are defined. In a case that the average arrival interval of packets at the UE changes (for example, from a value in a range of 0.1-1.0 to a value in a range of 1.0-100), the UE reports to the eNB the quantization level or an index value corresponding to the average arrival interval of packets.

TABLE 2
Quantization Table of Average Arrival Interval of Packets

| | Quantization | Average arrival interval of |
|---|---|---|
| Index | level | packets (second) |
| 00 | Very short | 0.001-0.1 |
| 01 | Short | 0.1-1.0 |
| 10 | Medium | 1.0-100 |
| 11 | Long | longer than 100 |

Aside from being triggered by the change of service characteristic, event-triggered reporting may be triggered by other factors, such as being triggered by change of a moving state. Three moving states for the UE are defined in the LTE system: normal speed, medium speed and high speed, and the moving state of the UE is determined according to the number of times for cell reselecting/handover in a time period. Utilizing a moving state estimation mechanism in existing standard, in a case that the moving state of the UE changes, the moving state reporting is triggered. For example, in a case that the moving state of the UE changes from medium speed to high speed, the changed moving state is reported to the eNB. The event-triggered reporting may be triggered by a change of moving speed. The UE measures the moving speed of itself, and in a case that a change in the moving speed succeeds a preset threshold, the UE triggers moving speed reporting, content of which is the specific moving speed.

The event-triggered reporting may also be triggered by a change of DRX configuration. The eNB configures a combination of several available DRX parameter configurations for the UE in advance, and the UE selects one of the configurations according to a certain criterion, and reports the information to the eNB. The eNB uses the information reported by the UE as a reference, and may perform configuration according to the selection of the UE, or may configure DRX parameters different from the selection of the UE. In a case that the DRX configuration selected by the UE changes, the UE reports to the eNB. For example, assuming that currently UE uses DRX configuration Configuration_{—}1, in a case that the UE decides to change the DRX configuration (for example, to Configuration_{—}2), the UE reports to the eNB, and content of the reporting is the changed DRX configuration (for example, Configuration_{—}2).

The periodical reporting and the event-triggered reporting may be used separately or in combination. In a case that the periodical reporting and the event-triggered reporting are used in combination, the periodical reporting ensures that the network may always be aware of information such as characteristic of a service carried out on the UE, a moving state, etc., and the event-triggered reporting ensures that the change of auxiliary information may be timely known by the network.

To avoid unnecessary information reporting, it may be considered to introduce a restricted mechanism for the reporting, in which the UE does not report a same item of auxiliary information in a time period T since the transmission of the auxiliary information.

Specifically, a reporting restricted timer may be defined for timing a period of T. The UE resets the reporting restricted timer after transmission of the auxiliary information, and does not report the auxiliary information repeatedly before the reporting restricted timer expires. The UE resets the periodical reporting timer each time finishing the reporting of the auxiliary information. Such a scheme is based on the consideration that the auxiliary information reporting triggered in a very short time period may have same content and will cause repetitive reporting and increased signaling overhead. The restricted mechanism for reporting may be applied to each item of auxiliary information independently (corresponding to the case that one item of the auxiliary information is reported independently), or may be applied to all items of the auxiliary information (corresponding to the case that all items of the auxiliary information are reported at the same time).

The foregoing embodiments are only preferred embodiments of the disclosure, and are not intent to limit the disclosure. Any modifications, alternatives and improvements within the spirit and principle of the disclosure fall within the scope of the disclosure.

What is claimed is:

1. A method for reporting auxiliary information by user equipment UE, wherein the method comprises:
transmitting, by a base station, a request signaling to the UE for requesting auxiliary information report; and
reporting, by the UE, the auxiliary information corresponding to the request signaling for requesting auxiliary information report to the base station upon receiving the request signaling.

2. The method according to claim 1, wherein the request signaling for requesting auxiliary information report corresponds to one item of the auxiliary information.

3. The method according to claim 1, wherein the request signaling for requesting auxiliary information report carries a list comprising multiple items of the auxiliary information.

4. A method for reporting auxiliary information by user equipment UE, wherein the method comprises:
configuring, by a base station, a reporting period for the UE; and
reporting, by the UE, the auxiliary information to the base station at a moment satisfying the reporting period.

5. The method according to claim 4, wherein the configuring, by the base station, the reporting period for the UE comprises: configuring, by the base station, a periodical reporting timer, which times for a time duration, for the UE through radio resource control RRC signaling; and
the reporting, by the UE, the auxiliary information to the base station at the moment satisfying the reporting period comprises: reporting, by the UE, the auxiliary information when the periodical reporting timer expires, and resetting the periodical reporting timer after reporting the auxiliary information.

6. The method according to claim 5, wherein each item of the auxiliary information corresponds to a separate periodical reporting timer, and/or multiple items of the auxiliary information correspond to a same periodical reporting timer.

7. A method for reporting auxiliary information by user equipment UE, wherein the method comprises:
determining, by the UE, whether a condition for reporting the auxiliary information is satisfied, if the condition is satisfied, reporting, by the UE, the auxiliary information corresponding to the condition.

8. The method according to claim 7, wherein the auxiliary information is a service characteristic, and the condition for reporting the auxiliary information is that the service characteristic changes and/or a change of the service characteristic succeeds a preset threshold, and the auxiliary information reported by the UE is the changed service characteristic.

9. The method according to claim 8, wherein a first mapping table is configured for the UE in advance, the first mapping table comprises at least two quantization levels, and each of the quantization levels corresponds to a numerical range of a corresponding service characteristic and a quantization level index;
the condition for reporting the auxiliary information is that a quantization level corresponding to the service characteristic of the UE changes; and
the auxiliary information reported by the UE is a quantization level corresponding to the changed service characteristic or an index value corresponding to the changed service characteristic.

10. The method according to claim 8, wherein the service characteristic is an average size of packets or an average arrival interval of packets.

11. The method according to claim 7, wherein the condition for reporting the auxiliary information is that a moving state of the UE changes, and the reported auxiliary information is the changed moving state.

12. The method according to claim 7, wherein the condition for reporting the auxiliary information is that a change in a moving speed of the UE succeeds a preset threshold, and the reported auxiliary information is a current moving speed.

13. The method according to claim 7, wherein the condition for reporting the auxiliary information is that a DRX configuration of the UE changes, and the reported auxiliary information is the changed DRX configuration.

14. The method according to claim 1, wherein the method further comprises: configuring, by the UE, a reporting restricted timer corresponding to the auxiliary information; and
reporting, by the UE, the auxiliary information comprises: determining, by the UE, whether the reporting restricted timer corresponding to the auxiliary information to be reported expires, if the reporting restricted timer expires, reporting the auxiliary information and resetting the reporting restricted timer, and if the reporting restricted timer does not expire, canceling the reporting of the auxiliary information.

15. The method according to claim 4, wherein the method further comprises: configuring, by the UE, a reporting restricted timer corresponding to the auxiliary information; and
reporting, by the UE, the auxiliary information comprises: determining, by the UE, whether the reporting restricted timer corresponding to the auxiliary information to be reported expires, if the reporting restricted timer expires, reporting the auxiliary information and resetting the reporting restricted timer, and if the reporting restricted timer does not expire, canceling the reporting of the auxiliary information.

16. The method according to claim 7, wherein the method further comprises: configuring, by the UE, a reporting restricted timer corresponding to the auxiliary information; and
reporting, by the UE, the auxiliary information comprises: determining, by the UE, whether the reporting restricted timer corresponding to the auxiliary information to be reported expires, if the reporting restricted timer expires, reporting the auxiliary information and resetting the reporting restricted timer, and if the reporting restricted timer does not expire, canceling the reporting of the auxiliary information.
